(19) United States
(12) Patent Application Publication
(10) Pub. No.: US 2024/0326658 A1
(43) Pub. Date: Oct. 3, 2024

(54) VEHICLE SEAT MOVEMENT PREVENTION SYSTEM AND METHOD

(71) Applicant: NISSAN NORTH AMERICA, INC., Franklin, TN (US)

(72) Inventors: Daniel AKM, Sterling Heights, MI (US); Evan FRANK, West Bloomfield, MI (US); Hiroyuki KITAGAWA, Commerce Charter Twp., MI (US); James KONRAD, Windsor, MI (US); Adam SHOMSKY, Farmington Hills, MI (US); Petar VUCELIC, Wixom, MI (US)

(21) Appl. No.: 18/191,475

(22) Filed: Mar. 28, 2023

(51) Int. Cl. B60N 2/02

(52) U.S. Cl. CPC B60N 2/0244; B60N 2/02246; B60N 2/0272

(57) ABSTRACT

A seat movement prevention system for a vehicle includes a seat, an actuator, a switch and an electronic controller. The seat is configured to move from a first position to a second position. The second position is different from the first position The actuator is configured to move the seat from the first position to the second position. The switch is configured to operate the actuator. The electronic controller is configured to disable the switch upon detecting a current shift position is not a park shift position.

### BACKGROUND

### Technical Field

The present disclosure generally relates to a vehicle seat movement prevention system and method. More specifically, the present disclosure relates to a vehicle seat movement prevention system and method that prevents a seat from moving when the vehicle is not in a park shift position.

### Background Information

Vehicles having a third row of seats conventionally have a second row of seats that can be moved to facilitate accessing and leaving the third row of seats.

### SUMMARY

An object of the present disclosure is to provide a system and method to prevent a vehicle seat from moving when the vehicle is not in a park shift position.

In view of the state of the known technology, one aspect of the present disclosure is to provide a seat movement prevention system for a vehicle including a seat, an actuator, a switch, and an electronic controller. The seat is configured to move from a first position to a second position. The second position is different from the first position The actuator is configured to move the seat from the first position to the second position. The switch is configured to operate the actuator. The electronic controller is configured to disable the switch upon detecting a current shift position is not a park shift position

Another aspect of the present disclosure is to provide a method of preventing seat movement. A switch is operable to move a seat from the first position to the second position. The second position is different from the first position. A current shift position of the vehicle is detected. The switch is disabled upon determining a current shift position is not a park shift position.

Also other objects, features, aspects and advantages of the disclosed vehicle seat movement prevention system and method will become apparent to those skilled in the art from the following detailed description, which, taken in conjunction with the annexed drawings, discloses exemplary embodiments of the vehicle seat movement prevention system and method.

### BRIEF DESCRIPTION OF THE DRAWINGS

Referring now to the attached drawings which form a part of this original disclosure:

FIG. 1 is an elevational view of a vehicle in which a seat is in a first position;

FIG. 2 is an elevational view of the seat of FIG. 1 in which the seat is in the first position;

FIG. 3 is a rear elevational view of the seat of FIG. 2 in which the seat is in the first position;

FIG. 4 is a side elevational view of the vehicle of FIG. 1 in which the seat is in the second position;

FIG. 5 is a rear perspective view of the seat of FIG. 3 in the second position;

FIG. 6 is a schematic diagram of a seat movement prevention system in accordance with an exemplary embodiment in which a current shift position is detected

FIG. 7 is a front elevational view of a vehicle display indicating the seat is in the second position;

FIG. 8 is a schematic diagram of a seat movement prevention system in accordance with another exemplary embodiment in which a voltage associated with a current shift position is detected; and

FIG. 9 is a schematic diagram of a seat movement prevention system in accordance with yet another exemplary embodiment including an accessor relay.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

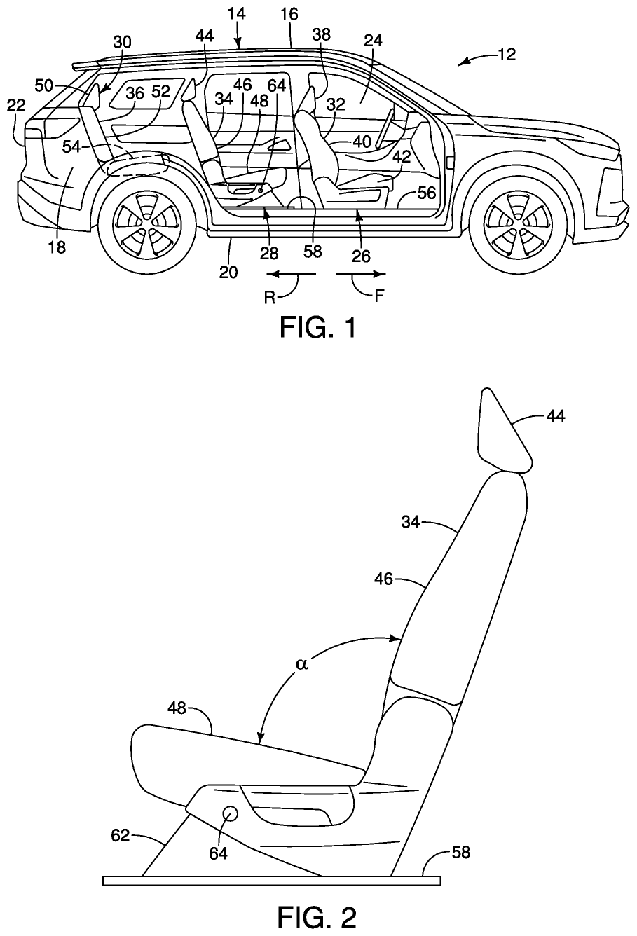

Referring initially to FIGS. 1-7, a system and method of preventing movement of a seat 10 of a vehicle 12 is illustrated in accordance with an exemplary embodiment. The vehicle 12 has a vehicle body structure 14 that includes at least a roof panel 16, side panels 18, a floor panel 20, and a rear wall portion 22 defining a cargo/passenger compartment 24.

The vehicle body structure 14 also includes various additional conventional structures, components and elements that are well known in the art. Since these structures, components and elements are well known in the art, further description is omitted for the sake of brevity.

As shown in FIG. 1, the passenger compartment 24 includes a front, or first, seat row 26, a rear, or second, seat row 28, and a third, or back, seat row 30. The second seat row 28 is disposed in a vehicle rearward direction R of the first seat row 26. The third seat row 30 is disposed in the vehicle rearward direction R of the second seat row 28. The first seat row 26 includes at least one front seat 32. The second seat row 28 includes at least one rear seat 34. The third seat row 30 includes at least one third row seat 36.

Each front seat 32 has a front headrest 38, a front seatback 40 and a front seat base, or cushion, 42. Each rear seat 34 has a rear headrest 44, a rear seatback 46, and a rear seat base 48. Each back seat 36 has a back headrest 50, a back seatback 52, and a back seat base 54. Each of the front seats 32, the rear seats 34, and the third row seats 36 is secured to a vehicle floor structure 56 in a conventional manner as discussed herein and as known in the art.

At least one of the rear seats 34, which can also be referred to as a vehicle seat assembly, is configured to provide access to the third row seats 36 in the third seat row 30. A plurality of slide rails, or tracks, 58 are connected to the vehicle floor structure 56, as shown in FIGS. 1-5. The rear seat 34 is slidably secured to the rails 58 of the vehicle floor structure 22 in a conventional manner. A plurality of slide carriages 60 connected to a seat frame 62 engage the rails 58 to provide movement of the rear seat 34 in the forward and rearward vehicle direction. The rear seatback 46 and the rear seat base 48 are supported by the seat frame 62 in a conventional manner. The seat frame 62 is pivotally connected to the carriages 60 such that the rear seat 34 is movable between a first position shown in FIG. 2 and a second position shown in FIG. 4. The second position is different from the first position.

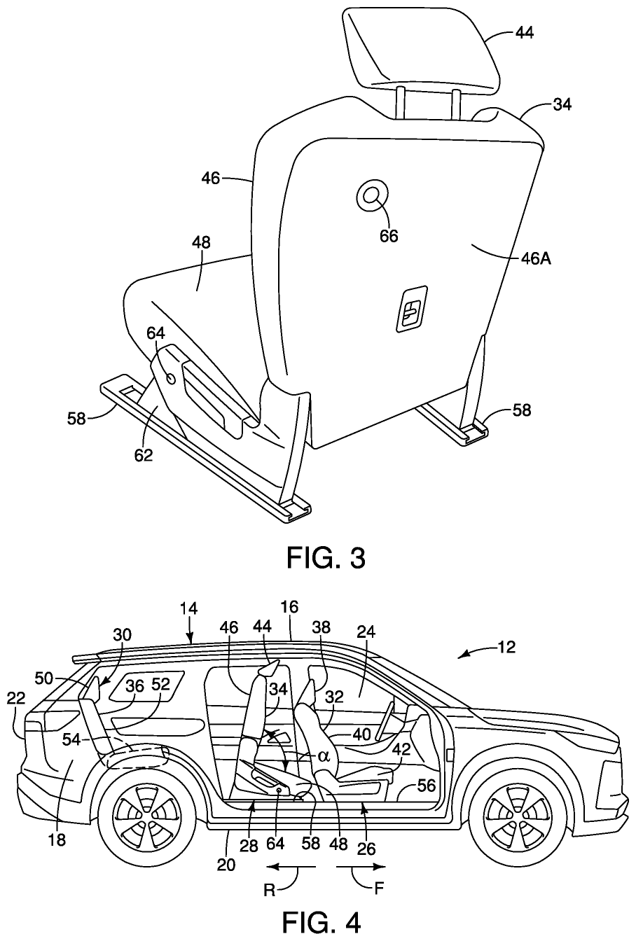

As shown in FIG. 2, the frame 62 of the rear seat 34 includes a first switch, or button, 64. The first switch 64 is disposed on an outboard side of the rear seat 34. As shown in FIG. 3, a rear surface 46A of the rear seatback 46 includes a second switch, or button, 66. The rear seat 34 is configured to move from the first position to the second position in a conventional manner. Operating either the first switch 64 or the second switch 66 moves the rear seat 34 from the first, or non-moved, position, shown in FIG. 2, to the second, or moved, position, shown in FIG. 4.

The rear seat 34 moves in a conventional manner from the first position to the second position. The second position can be a position in which the rear seat 34 pivots and slides from the first position and in which an angle a between the rear seatback 46 and the rear seat base 48 remains substantially the same in the first and second positions. Alternatively, the second position can be a position in which the rear seat 34 pivots and slides from the first position and in which an angle a between the rear seatback 46 and the rear seat base 48 changes from the first to the second position. The second position is any suitable position facilitating accessing and leaving the third row of seats 30. The rear seat 34 is manually returned from the second position to the first position in a conventional manner.

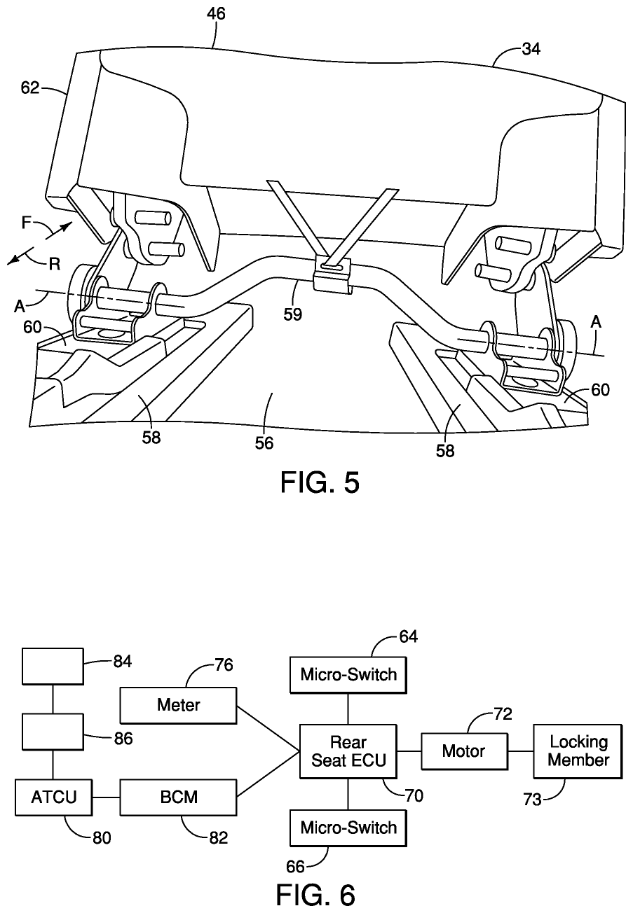

The first position of the rear seat 34, as shown in FIG. 2, is a locked position of the rear seat 34 during operation of the vehicle 12. The second position of the rear seat 34, as shown in FIGS. 4 and 5, is a moved position in which the rear seat 34 is unlocked and slides in a forward direction F of the vehicle 12 along the rails 58 and pivots a predetermined angle about a pivot axis A to facilitate accessing and leaving the third row of seats 30. A pivot bar 59 is connected between the carriages 60 and the seat frame 62 to allow the rear seat 34 to pivot about the pivot axis A with respect to the rails 58. The carriages 60 roatably receive the pivot bar 59 such that the carriages 60 do not rotate with the pivot bar 59. The pivot bar 59 being received by the carriages causes lateral movement of the pivot bar 59 and the attached seat frame 62 with lateral movement of the carriages 60. The predetermined pivot angle is conventional, such as approximately fifteen degrees. The predetermined pivot angle can be any suitable angle facilitating entering and exiting the third seat row 30. The predetermined angle is the angle between the rear seat back 46 in the first position (FIG. 2) and the rear seat back 46 in the second position (FIG. 4). In one embodiment, the angle a between the rear seat back 46 and the rear seat base 48 does not change when the rear seat 34 moves from the first position (FIG. 2) to the second position (FIG. 4), such that an object, such as a car seat, does not need to be removed from the rear seat 34 when moving the rear seat 34 between the first and second positions. In another embodiment, the angle a between the rear seat back 46 and the rear seat base 48 decreases when the rear seat 34 moves from the first position to the second position. The movement of the rear seat 34 from the first position to the second position is any movement facilitating ingress and egress to and from the third row of seats 30.

A seat movement prevention system 68 is illustrated in FIG. 6. The system 68 includes an electronic controller 70, an actuator 72, and the first and second switches 64 and 66. The actuator 72 is configured to move the rear seat 34 from the first position (FIG. 2) to the second position (FIG. 4) in a conventional manner when one of the first and second switches 64 and 66 is operated. Operating, such as pressing, one of the first and second switches 64 and 66 activates the actuator 72 to move the rear seat 34 from the first position to the second position. A locking member 73 locks the rear seat 34 in the first position and prevents movement of the rear seat 34 to the second position. Operating one of the first and second switches 64 and 66 activates the actuator 72 to move the locking member 73 to an unlocked position. The actuator 72 can be any suitable device configured to move the locking member 73 from the locked position to the unlocked position, such as a motor. When the locking member 73 is moved to the unlocked position, a biasing member is configured to move the rear seat 34 from the first position (FIG. 2) to the second position (FIG. 4). The biasing member is any suitable member, such as a torsion spring.

The first and second switches 64 and 66 transmit a signal to the electronic controller 70, which activates the actuator 72 when one of the first and second switches 64 and 66 is operated. The electronic controller 70 is configured to disable the first and second switches 64 and 66 upon detecting a current shift position of the vehicle 12 is not a park shift position. In other words, when the current shift position of the vehicle 12 is not the park shift position, such as a drive, neutral, low or reverse shift position, operation of the first and second switches 64 and 66 does not cause the electronic controller 70 to activate the actuator 72 to unlock the locking member 73 to move the rear seat 34 from the first position to the second position. The electronic controller 70 determines that the vehicle 12 is not currently in the park shift position, such that a signal is not transmitted to the actuator 72 to move the rear seat 34, which disables the first and second switches 64 and 66. In other words, the electronic controller 70 does not transmit a signal to the actuator 72 to move the locking member 73 to the unlocked position when the vehicle is determined to not be in the park shift position. When the vehicle is detected to currently be in the park shift position, the first and second switches 64 and 66 are enabled and the electronic controller controls the actuator 72 to move the rear seat 34 when one of the first and second switches 64 and 66 is operated.

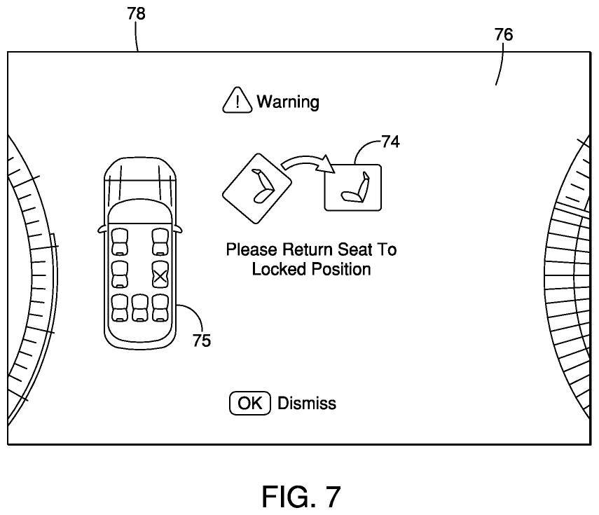

When the vehicle 12 is detected as not currently being in the park shift position, operation of the first and second switches 64 and 66 is prevented from moving the rear seat 34 from the first position to the second position. When the vehicle 12 is detected as being in the park shift position, operation of either of the first and second switches 64 and 66 moves the rear seat 34 from the first position to the second position. When the rear seat 34 is moved to the second position, an indication 74 is displayed on a display 76 of a vehicle dashboard 78, as shown in FIG. 7. The indication 74 provides a visual indication to a driver of the vehicle 12 that the rear seat 34 is currently in the second position, such that the rear seat 34 can be manually returned to the first position. The display 76 further includes an image 75 of the vehicle indicating which rear seat 34 is currently in the second, or moved, position. As shown in FIG. 7, the image 75 indicates that the passenger side rear seat is currently in the second, or moved, position. Alternatively, the indication can be provided audibly from a speaker disposed in the passenger compartment 24 of the vehicle 12.

The indication 74 also provides a visual or audible indication that the actuator moved the locking member 73 to the unlocked position. An object positioned on the rear seat 34 can prevent movement of the rear seat from the first position to the second position when one of the first and second switches 64 and 66 is operated. The indication 74 indicates that the rear seat 34 is in the unlocked position, although the rear 34 has not moved from the first position to the second position.

The seat movement prevention system 68 illustrated in FIG. 6 further includes an automatic transmission control unit (ATCU) 80, a body control module (BCM) 82, a transmission lever 84, and a gear, or shift, position sensor 86. The automatic transmission control unit 80 is an electronic controller configured to control the automatic transmission of the vehicle 12. The body control module 82 is an electronic controller configured to monitor and control various electronic accessories of the vehicle 12. The electronic controller 70, the display 76, the automatic transmission control unit 80, and the body control module 82 are preferably connected by a vehicle controller area network bus, or vehicle bus, but can be connected in any suitable manner. The current shift position is transmitted to the electronic controller 70 via the controller area network bus.

The gear position sensor 86 detects a current shift position of the transmission lever 84 of the vehicle 12 and transmits a signal to the automatic transmission control unit 80 indicating the current shift position of the transmission lever 84. The automatic transmission control unit 80 transmits a signal to the body control module 82 indicating the current shift position of the shift position lever 84. The body control module 82 transmits the current shift position of the shift position lever 84 to the electronic controller 70. Based on the current shift position of the shift position lever 84, the electronic controller 70 allows or prevents movement of the rear seat 34 from the first position (FIG. 2) to the second position (FIG. 4). The first and second switches 64 and 66 are enabled when the current shift position is the park shift position. The first and second switches 64 and 66 are disabled when the current shift position is not the park shift position, such as the drive, reverse, neutral and low shift positions. When the first and second switches 64 and 66 are disabled, operation of either of the first and second switches 64 and 66 does not move the rear seat 34 from the first position (FIG. 2) to the second position (FIG. 4). In other words, the electronic controller 70 does not transmit a signal to the actuator 72 to move the locking member 73 to the unlocked position, such that the rear seat 34 is prevented from moving from the first position to the second position.

Disabling the first and second switches 64 and 66 when the vehicle is not currently in the park shift position, prevents movement of the rear seat 34 to the second position when one of the first and second switches 64 and 66 is operated, such as when the vehicle 12 is traveling with the transmission lever 84 in the drive shift position. When the transmission lever 84 is determined to be shifted to the park shift position, the first and second switches 64 and 66 are enabled, such that the rear seat 34 can be moved to the second position to facilitate entering and leaving the third seat row 30. As shown in FIG. 7, the indication 74 is displayed on the display 76 to alert the driver of the vehicle 12 that the rear seat 34 has been moved to the second position (FIG. 4), or that the rear seat 34 is in the unlocked position.

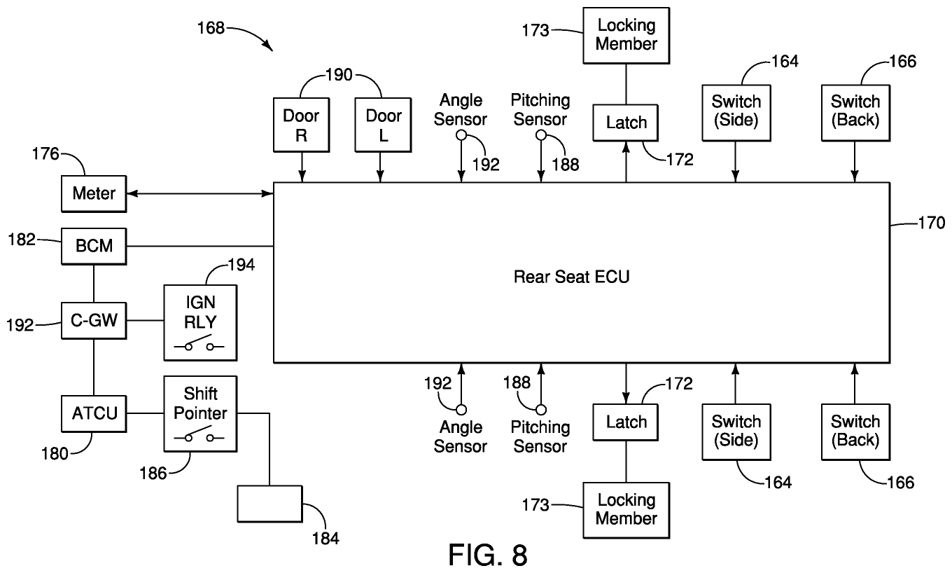

As shown in FIG. 8, a vehicle seat movement prevention system and method 168 in accordance with another illustrated exemplary embodiment of the present invention is substantially similar to the vehicle seat movement prevention system and method 68 of the exemplary embodiment illustrated in FIGS. 1 to 7 except for the differences described below. Similar parts are identified with similar reference numerals, except increased by 100 (i.e., 1xx, accordingly).

As shown in FIG. 8, the electronic controller 170 includes first and second switches 164 and 166 for each of two rear seats. In other words, the first and second switches shown above the electronic controller 170 in FIG. 8 operate one of the rear seats. and the first and second switches shown below the electronic controller operate the other of the rear seats. Each of the first and second switches 164 and 166 can include an LED controlled by the electronic controller 170 to illuminate the first and second switches to facilitate visibility.

Each of the rear seats includes the actuator, or motor, 172 to move the rear seat from the first position to the second position. The actuator 172 moves the locking member 173 from the locked position to the unlocked position such that a biasing member moves the rear seat from the first position to the second position. Each of the rear seats has a pitching sensor 188 that determines whether the rear seat is in the second position. As shown in FIG. 7, the electronic controller 170 receives a signal from one of the pitching sensors 188 when the respective rear seat is moved to the second position or when the locking member 173 is moved to the unlocked position, and causes the indication to be displayed on the display 176. Each of the rear doors includes a sensor 190 that transmits a signal to the electronic controller when the respective door is opened. Receiving a door open signal from one of the rear door sensors 190 wakes up the electronic controller 170.

Each of the rear seats includes a seat angle position sensor 192, as shown in FIG. 8. The seat angle position sensor 192 determines the angle a between the seat base (48) and the seat back (46), as shown in FIG. 2. The electronic controller 170 prevents movement of the rear seat from the first position to the second position when the detected seat angle α is below or above a predetermined range. In other words, the electronic controller 170 is configured to disable the switches 164 and 166 associated with the rear seat upon detecting the seat angle of the rear seat is below or above the predetermined range. The predetermined range can be any suitable seat angle, such as between approximately 80 and approximately 105 degrees. When the detected seat angle of the rear seat is less than approximately 80 degrees or larger than approximately 105 degrees, the first and second switches 164 and 166 are disabled and the rear seat is prevented from moving from the first position to the second position.

The seat movement prevention system 168 illustrated in FIG. 8 further includes the automatic transmission control unit (ATCU) 180, the body control module (BCM) 182, the transmission lever 184, and the gear, or shift, position sensor 186. The shift position sensor 186 is configured to determine a voltage associated with the selected shift position of the transmission lever 184. The voltage associated with a shift position of drive, neutral, reverse, or low is approximately 2.4 volts. The voltage associated with a shift position of park is approximately 0 volts. The sensor 186 detects the voltage of the current shift position to determine the current shift position. The detected voltage is transmitted from the sensor 186 through a central gateway 192 to the body control module 182, which transmits the detected voltage to the electronic controller 170. When the voltage detected by the sensor 186 indicates the vehicle is not currently in the park shift position, the first and second switches 164 and 166 are disabled such that the rear seat is prevented from being moved from the first position to the second position. In other words, the electronic controller 170 does not transmit a signal to the actuator 172 to move the locking member 173 to the unlocked position when the vehicle is currently detected to not be in the park shift position.

The seat movement prevention system 168 illustrated in FIG. 8 further includes a conventional ignition relay 194. The ignition relay 194 is turned on to direct power to the vehicle components, such as the body control module 182 and the automatic transmission control unit 180. The central gateway 192 is a communication node for the vehicle bus and connects the body control module 182 with the automatic transmission control unit 180. The body control module 182, the central gateway 192 and the automatic transmission control unit 180 are preferably connected by the vehicle bus, although any suitable connection facilitating communication therebetween can be used.

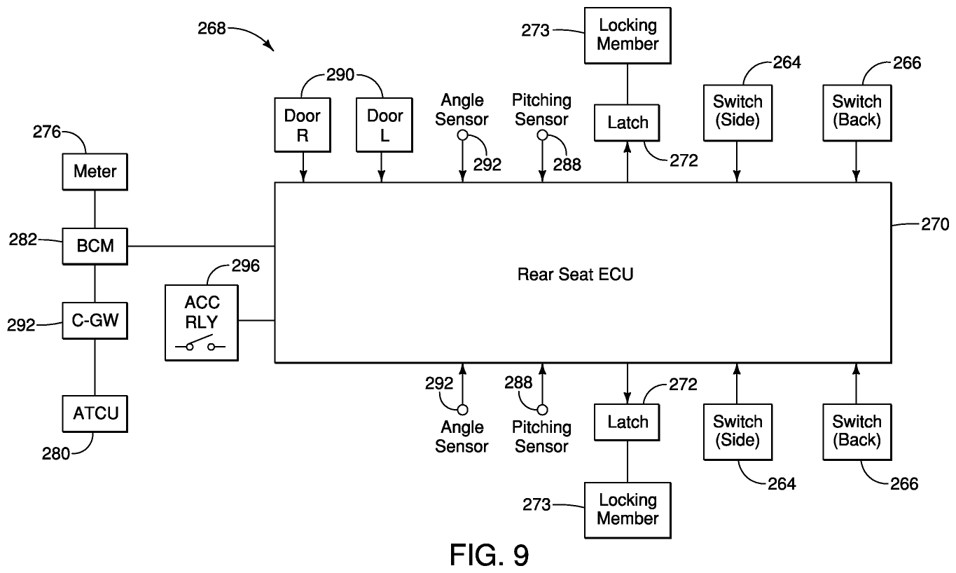

As shown in FIG. 9, a vehicle seat movement prevention system and method 268 in accordance with another illustrated exemplary embodiment of the present invention is substantially similar to the vehicle seat movement prevention systems and methods 68 and 168 of the exemplary embodiments illustrated in FIGS. 1 to 8 except for the differences described below. Similar parts are identified with similar reference numerals, except increased by 200 (i.e., 2xx, accordingly).

As shown in FIG. 9, the electronic controller 270 includes first and second switches 264 and 266 for each of two rear seats. In other words, the first and second switches shown above the electronic controller 270 in FIG. 9 operate one of the rear seats, and the first and second switches shown below the electronic controller operate the other of the rear seats. Each of the first and second switches 264 and 266 can include an LED controlled by the electronic controller 270 to illuminate the first and second switches to facilitate visibility.

Each of the rear seats includes the actuator, or motor, 272 to move the rear seat from the first position to the second position. The actuator 272 moves the locking member 273 from the locked position to the unlocked position such that a biasing member moves the rear seat from the first position to the second position. Each of the rear seats has a pitching sensor 288 that determines whether the rear seat is in the second position. As shown in FIG. 7, the electronic controller 270 receives a signal from one of the pitching sensors 188 when the respective rear seat is moved to the second position or when the locking member 273 is moved to the unlocked position, and causes the indication to be displayed on the display 276. Each of the rear doors includes a sensor 290 that transmits a signal to the electronic controller when the respective door is opened. Receiving a door open signal from one of the rear door sensors 290 wakes up the electronic controller 270.

Each of the rear seats includes a seat angle position sensor 292, as shown in FIG. 9. The seat angle position sensor 292 determines the angle a between the seat base (48) and the seat back (46), as shown in FIG. 2. The electronic controller 270 prevents movement of the rear seat from the first position to the second position when the detected seat angle a is below or above a predetermined range. In other words, the electronic controller 270 is configured to disable the switches 264 and 266 associated with the rear seat upon detecting the seat angle of the rear seat is below or above the predetermined range. The predetermined range can be any suitable seat angle, such as between approximately 80 and approximately 105 degrees. When the detected seat angle of the rear seat is less than approximately 80 degrees or larger than approximately 105 degrees, the first and second switches 264 and 266 are disabled and the rear seat is prevented from moving from the first position to the second position.

The seat movement prevention system 168 illustrated in FIG. 9 further includes the automatic transmission control unit (ATCU) 280, the body control module (BCM) 282, and the accessory relay (ACC RLY) 296. The accessory relay 296 is configured to detect when the vehicle is in the accessory off position. The electronic controller 270 is configured to disable the first and second switches 264 and 266 after a predetermined time period upon detecting the vehicle is in the accessory off position. The predetermined time period can be any suitable amount of time, such as ten minutes. The accessory relay 296 is connected to the electronic controller 270 in any suitable manner, such as hardwired. When the vehicle is in the accessory on position, the vehicle controller area network bus communicates with the electronic controller 270, such that the first and second switches 264 and 266 can move the rear seat to the second position when the vehicle is detected to currently be in the park shift position. When the vehicle is in the accessory off position, the vehicle controller area network bus communication to the electronic controller 270 is stopped. The first and second switches 264 and 266 are operable during the predetermined amount of time. When the predetermined amount of time has elapsed, the electronic controller 270 enters a sleep mode in which the first and second switches 264 and 266 are disabled. The electronic controller 270 enters an awake mode when the accessory relay 296 detects the vehicle is in the accessory on position, and the first and second switches 264 and 266 can move the rear seat to the second position when the vehicle is detected as currently being in the park shift position.

The central gateway 292 is a communication node for the vehicle bus and connects the body control module 282 with the automatic transmission control unit 280. The body control module 282, the central gateway 292 and the automatic transmission control unit 280 are preferably connected by the vehicle bus, although any suitable connection facilitating communication therebetween can be used.

### GENERAL INTERPRETATION OF TERMS

The controllers preferably include a microcomputer with a control program that controls various operations as discussed above. The controllers can also include other conventional components, such as an input interface circuit, an output interface circuit, and storage devices, such as a ROM (Read Only Memory) device and a RAM (Random Access Memory) device. The microcomputers of the controllers are programmed to control the various operations discussed above. The memory circuit stores processing results and control programs, such as ones for operations that are run by the processor circuits. The internal RAM of the controllers stores statuses of operational flags and various control data. The internal ROM of the controllers store the information for various operations. The controllers are capable of selectively controlling any of the components of the control system in accordance with the control program.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle seat movement prevention system and method. Accordingly, these terms, as utilized to describe the present invention should be interpreted relative to a vehicle equipped with the vehicle seat movement prevention system and method.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A seat movement prevention system for a vehicle comprising:
a seat configured to move from a first position to a second position, the second position being different from the first position;
an actuator configured to move the seat from the first position to the second position;
a switch configured to operate the actuator; and
an electronic controller configured to disable the switch upon detecting a current shift position is not a park shift position.

2. The seat movement prevention system according to claim 1, wherein
a shift position sensor detects a current shift position of the vehicle.

3. The seat movement prevention system according to claim 1, wherein
the switch being enabled upon detecting the current shift position is the park shift position.

4. The seat movement prevention system according to claim 1, wherein
an indicator is displayed indicating the seat is in the second position.

5. The seat movement prevention system according to claim 1, wherein the switch is disposed on the seat back of the seat.

6. The seat movement prevention system according to claim 1, wherein
the switch is disposed on an outboard side of the seat.

7. The seat movement prevention system according to claim 1, wherein
a seat angle position sensor is configured to determine a seat angle between the seat base and the seat back.

8. The seat movement prevention system according to claim 7, wherein
the electronic controller is further configured to disable the switch upon detecting the seat angle is below or above a predetermined range.

9. The seat movement prevention system according to claim 8, wherein
the predetermined range is approximately 80 to 105 degrees.

10. The seat movement prevention system according to claim 1, wherein
the vehicle includes a first row of seats, a second row of seats, and a third row of seats, the seat being in the second row of seats.

11. The seat movement prevention system according to claim 1, wherein
an angle between a seat base and a seat back of the are substantially the same in the first position and the second position.

12. The seat movement prevention system according to claim 1, wherein
the current shift position is determined through a voltage associated with the current shift position.

13. The seat movement prevention system according to claim 1, wherein
an accessory relay detects when the vehicle is in the accessory off position, the electronic controller being further configured to disable the switch after a predetermined time period upon detecting the vehicle is in the accessory off position.

14. A method of preventing seat movement comprising:
operating a switch to move a seat from the first position to the second position, the second position being different from the first position;
detecting a current shift position of the vehicle; and
disabling the switch upon determining a current shift position is not a park shift position.

15. The method of preventing seat movement according to claim 14, further comprising
enabling the switch upon determining the current shift position is the park shift position.

16. The method of preventing seat movement according to claim 14, wherein
the current shift position is transmitted through a vehicle controller area network bus.

17. The method of preventing seat movement according to claim 14, further comprising
detecting a voltage associated with the current shift position to determine the current shift position.

18. The method of preventing seat movement according to claim 14, further comprising
disabling the switch upon determining the seat angle is below or above a predetermined range.

19. The method of preventing seat movement according to claim 18, further comprising
detecting whether the vehicle is in an accessory off position, the electronic controller being further configured to disable the switch after a predetermined time period upon detecting the vehicle is in the accessory off position.

20. The method of preventing seat movement according to claim 14, further comprising
displaying an indication that the seat is in the second position.
